(19) United States
(12) Patent Application Publication
(10) Pub. No.: US 2014/0027292 A1
(43) Pub. Date: Jan. 30, 2014

(54) LITHIUM-ION BATTERY PRECURSOR INCLUDING A SACRIFICIAL LITHIUM ELECTRODE AND A NEGATIVE TEXTILE CONVERSION ELECTRODE

(71) Applicant: ELECTRICITE DE FRANCE, Paris (FR)

(72) Inventors: Elodie Vidal, Montigny Sur Loing (FR); Stephane Lascaud, Fontainebleau (FR)

(73) Assignee: ELECTRICITE DE FRANCE, Paris (FR)

(21) Appl. No.: 14/041,612

(22) Filed: Sep. 30, 2013

Related U.S. Application Data
(63) Continuation-in-part of application No. PCT/FR2012/050718, filed on Apr. 3, 2012.

(30) Foreign Application Priority Data
Apr. 6, 2011 (FR) 1152974

(51) Int. Cl. H01M 4/04; H01M 4/1395

(52) U.S. Cl. CPC H01M 4/045; H01M 4/1395
USPC 205/59; 429/142

(57) ABSTRACT

The invention relates to a lithium-ion accumulator precursor and to a method for producing an accumulator from such a precursor.

### CROSS-REFERENCE TO RELATED APPLICATIONS

This application is a continuation-in-part of International Patent Application No. PCT/FR2012/050718, filed Apr. 3, 2012, and published as WO 2012/136926, which in turn claims priority to FR 1152974, filed Apr. 6, 2011.

The foregoing applications, and all documents cited therein or during their prosecution (“appin cited documents”) and all documents cited or referenced in the appin cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The invention relates to a precursor of a lithium-ion accumulator containing a sacrificial metallic-lithium electrode, and to a method for producing a lithium-ion accumulator from such a precursor.

BACKGROUND

The terminology “lithium-ion” (Li-ion) generally defines a technology in which the cathode comprises an insertion material comprising lithium, the anode comprises at least one material that reacts electrochemically and reversibly with lithium, and the electrolyte contains lithium ions. The material that reacts electrochemically and reversibly with lithium is, for example, an insertion material, containing or not containing lithium, or carbon. The electrolyte generally contains fluorinated salts of lithium in solution in an aprotic organic solvent.

French patent application FR 2 870 639 in the name of the Applicant describes an electrode for lithium-ion accumulators which is characterized by the presence, on the surface of the electron collector, of a layer of electrochemically active material which is “nanostructured”, containing nanoparticles composed of a compound, as for example an oxide, of the metal or metals forming the electron collector. The particular structure of the electrochemically active material enhances the performance of the accumulators in terms of power and of energy density per unit mass.

French patent application FR 2 901 641, likewise in the name of the Applicant, describes an enhancement to the nanostructured electrode above, residing primarily in the textile structure of the electrode and of the half-accumulators (electrode+separator) manufactured from said electrode.

When the manufacture of lithium-ion batteries containing such nanostructured electrodes is carried out using, as sole lithium source, the positive electrode generally formed by a composite material based on lithium-containing oxides, the following problem is encountered:

During the first charge of the battery, the electrochemical reaction involving the lithium ions provided by the positive electrode and resulting, as desired, in the formation of the nanostructured conversion layer at the surface of the negative electrode, proves to be partially irreversible. This irreversibility is manifested in the definitive fixation of some of the lithium ions in the conversion layer of the negative electrode.

Furthermore, during the first discharge of the battery, it may be desirable to limit the amount of lithium ions extracted from the nanostructured conversion layer, in order to conserve the lifetime of said layer.

Some of the lithium ions initially introduced are no longer available for the charge/discharge cycles, and so the result is a reduction in the capacity of the accumulator. The positive electrode which is the initial source of lithium ions, though, is dimensioned, in terms of mass and volume, such that the amount of lithium ions it is able to provide allows the complete conversion of the negative electrode. The reduction in capacity is therefore manifested in an underutilization of the positive electrode during cycling of the battery, starting from the second cycle. In other words, the reduction in capacity leads, undesirably, to an overdimensioning of the positive electrode, to an excess cost, and to a surplus of mass of the elements making up the positive electrode.

### SUMMARY OF THE INVENTION

The invention relates to a lithium-ion accumulator precursor, comprising:
one or more electrode modules each formed by
   (a) at least one textile negative electrode precursor, composed of a textile metallic structure, oxidized at the surface, based on one or more transition metals from groups 4 to 12 of the Periodic Table of the Elements,
   (b) a polymeric separator, impregnated with a solution of a lithium salt in an aprotic organic solvent, said separator covering the surface of the negative electrode precursor,
   (c) a positive electrode forming a solid, preferably continuous, matrix which encloses the structure formed by (a) and (b), and
at least one metallic lithium electrode, separated from the electrode module or modules by a polymeric separator impregnated with a solution of a lithium salt in an aprotic organic solvent,

characterized in that the ratio of the geometric surface area of the lithium strip to the cumulative geometric surface area of all of the textile negative electrode precursors is within the range from 0.05 to 0.33, preferably from 0.1 to 0.25.

The invention also relates to a method for producing an accumulator from such a precursor.

### BRIEF DESCRIPTION OF THE DRAWINGS

FIG. 1 represents an embodiment of an accumulator precursor of the present invention, and

FIGS. 2 and 3 represent the same accumulator precursor, respectively, during the first and second steps in the method for producing an accumulator of the present invention.

### DETAILED DESCRIPTION

The idea on which the present invention is based was to compensate the lithium ions irreversibly and/or voluntarily immobilized in the negative electrode by the provision of lithium ions from a sacrificial electrode.

The use of sacrificial lithium electrodes for the manufacture of accumulators is already known.

For example, patent U.S. Pat. No. 5,871,863 discloses the use of a sacrificial lithium electrode with the aim of increasing the capacity, in terms of mass and volume, of positive electrodes based on lithiated manganese oxide (LiMn₂O₄), this material having a volume capacity that is lower by 10% to 20% than that of the LiCoO₂ material presented as reference material. A sacrificial lithium or lithium alloy strip is contacted directly or indirectly with the positive electrode composed of lithiated manganese oxide. In one embodiment an electron conductor is intercalated between the lithium strip and the positive electrode in order to limit the exothermic nature of the self-discharge reaction between these two elements in the presence of an electrolyte solution. This self-discharge reaction leads to the insertion of an additional amount of lithium ions into the positive electrode material. Owing to the sheet structure of the electrodes and of the accumulator, it is necessary, in order to guarantee uniform distribution of the lithium ions, to apply the strip to the whole of the surface of the positive electrode; in other words, the ratio between the geometric surface area of the lithium strip and the cumulative geometric surface area of the positive electrodes must not be too low and must ideally tend toward 1 (when the whole surface of the positive electrodes is covered by the lithium strip). The thickness of the strip used in the example of U.S. Pat. No. 5,871,863 is 30 μm.

The Applicant, in the context of its research aiming to perfect lithium-ion accumulators comprising nanostructured electrodes as described in FR 2 901 641, has found that, by virtue of the textile structure of the negative electrodes and by virtue of a particular arrangement of the various components of the accumulator, it was possible to use metallic lithium as a source of lithium in order to compensate for the reduction in capacity observed or desired at the end of the first charge/discharge cycle, in a way which is much simpler than in the above-discussed patent U.S. Pat. No. 5,871,863.

The reason is that in the accumulator precursor of the present invention, described in detail hereinafter, the fact that the textile structure of the nanostructured negative electrodes, even when they are stacked on one another or wound around each other, allows the passage of lithium ions in all directions, and especially in a direction perpendicular to the plane of the textile electrodes, is exploited. The result is a regular diffusion of the lithium ions throughout the accumulator and/or accumulator precursor.

In the present invention, therefore, it is unnecessary to apply a lithium strip to each of the lithium-receiving electrodes (as in U.S. Pat. No. 5,871,863); instead, a single lithium strip, or a small number of strips, with a thickness that is relatively greater, is sufficient to introduce the desired amount of lithium in a regular way into all of the negative electrodes receiving lithium ions.

The present invention accordingly provides a lithium-ion accumulator precursor comprising not only one or more superposed nanostructured textile electrodes but also at least one sacrificial lithium electrode, in other words an electrode made of lithium or lithium alloy that will be partly or entirely consumed during the production of the definitive accumulator (first charge) from the accumulator precursor.

The accumulator precursor of the present invention comprises
one or more electrode modules each formed by
(a) at least one textile negative electrode precursor, composed of a textile metallic structure, oxidized at the surface, based on one or more transition metals from groups 4 to 12 of the Periodic Table of the Elements,
(b) a polymeric separator, impregnated with a solution of a lithium salt in an aprotic organic solvent, said separator covering the entire surface of the textile negative electrode precursor (a),
(c) a positive electrode forming a solid, preferably continuous, matrix which encloses the structure formed by (a) and (b), and
at least one metallic lithium electrode, preferably formed by a metallic lithium strip supported by an electrical conductor, and separated from the electrode module or modules by a polymeric separator impregnated with a solution of a lithium salt in an aprotic organic solvent,
the ratio of the geometric surface area of the lithium strip to the cumulative geometric surface area of all of the textile negative electrode precursors is within the range from 0.05 to 0.33, preferably from 0.1 to 0.25.

The accumulator precursor of the present invention thus comprises one or more “electrode modules” each composed of a positive electrode that forms a matrix, preferably a continuous matrix, which encloses a textile negative electrode precursor or a stack of two or more textile negative electrode precursors, a polymeric separator impregnated with a liquid electrolyte coating the fibers of the negative electrode precursor and thus insulating it completely from the positive electrode.

The positive electrode is formed by a lithium ion insertion material commonly used in lithium-ion accumulators. Materials of this kind are known to the skilled person. Examples of such materials include, for example, at least one material selected from the group consisting of LiCoO₂, LiNiₓCo_{y}Mn_{z}O₂ where x>0, y>0, Z>0, with x+y+z=1, LiNiₓMn₁₋ₓO₂ where 1≧x>0, LiNiₓCo_{y}Al_{z}O₂ where x>0, y>0, z>0 with x+y+z=1, LiFePO₄ or LiMn₂O₄, or a compound of type LiMX₂ where M is a transition metal and X represents a halogen atom. The positive electrode further advantageously comprises a polymeric binder, preferably poly(vinylidene fluoride) (PVDF) or a copolymer of vinylidene fluoride and hexafluoropropylene (PVDF-HFP), and carbon.

Each negative electrode precursor comprises
an electron collector containing one or more transition metals from groups 4 to 12 of the Periodic Table of the Elements, and
on the surface of the electron collector, an oxide layer formed by oxidation of the electron collector.

During the production of the accumulator from the accumulator precursor of the present invention, the layer of oxide of at least one transition metal on the surface of the electron collector will react with the lithium ions coming from the sacrificial lithium electrode and from the positive electrode, to form a nanostructured conversion layer. This nanostructured conversion layer, described in detail in patent applications FR 2 870 639 and FR 2 901 641, constitutes the electrochemically active material of the negative electrode of the lithium-ion accumulator. It contains nanoparticles having an average diameter of between 1 and 1000 nm, preferably between 10 and 300 nm, or agglomerates of such nanoparticles.

The transition metal or metals of the electron collector are preferably selected from the group consisting of nickel, cobalt, manganese, copper, chromium and iron, with iron being particularly preferred.

In one particularly preferred embodiment, the textile negative electrode precursor is made of unalloyed or low-alloy steel, oxidized at the surface.

The negative electrode precursor and the negative electrode have a textile structure, in other words a structure composed of a multitude of fibers which are juxtaposed and/or intermingled, in an ordered or disordered way. The structure in question may in particular be a woven textile structure or a non-woven textile structure.

The textile structure used to form the negative electrode precursor is preferably formed of very fine threads with little space between one another. The reason is that the finer the threads and the greater the number of threads per unit surface area, the higher the specific surface area (determined by BET or by electrochemical impedance spectroscopy). The fineness of the wires may, however, be limited by the capacity for the metals or metal alloys used to be drawn. Whereas certain metals and alloys, such as copper, aluminum, bronze, brass, and certain steels alloyed with chromium and with nickel, lend themselves very well to drawing and hence may be obtained in the form of very fine wires, other metals or alloys, such as ordinary steels, are more difficult to draw and are more suitable for structures having short fibers, such as nonwovens.

Generally speaking, the equivalent diameter of the cross section of the metallic wires or metallic fibers constituting the negative electrode precursor is between 5 μm and 1 mm, preferably between 10 μm and 100 μm and more particularly between 15 μm and 50 μm. By “equivalent diameter” is meant the diameter of the circle possessing the same surface area as the cross section of the wires or fibers.

In the negative electrode, the conversion layer (electrochemically active material) preferably covers the whole surface of the electron collector and preferably has a thickness of between 30 nm and 15 000 nm, more particularly between 30 nm and 12 000 nm.

The precursor of the textile negative electrode preferably has a non-woven structure formed of short fibers preferably having an average length of between 1 cm and 50 cm, preferably between 2 cm and 20 cm, and an equivalent diameter of between 5 μm and 50 μm.

The Applicant preferably uses steel wool felts that are available commercially. These felts preferably have a density of between 0.05 and 5 g/cm³, more particularly between 1 and 3 g/cm³, these values being those determined on a felt compressed by application of a pressure of 1 bar.

The negative electrode precursor, owing to its textile structure, is permeable to ions, and more particularly to the lithium ions coming from the sacrificial electrode. When this textile structure is very dense, it may be desirable to increase this permeability or “porosity” by making holes or openings in the textile structure, preferably distributed regularly over the entire surface of the textile structure. These holes then add to those which are naturally present in the textile structure. When reference is made, in the present patent application, to the “holes” or “openings” in the precursor of the negative textile electrode, this term always encompasses the openings intrinsic to the textile structure and those possibly produced, for example, by piercing of the textile structure.

The negative electrode precursor surface is covered over its entire surface with a polymeric coating which provides the function of a separator. In the accumulator precursor of the present invention, this polymeric coating is impregnated and swollen with an aprotic liquid electrolyte containing at least one lithium salt. In the present invention, the separator coating swollen with the liquid electrolyte is preferably thin enough for the textile structure of the negative electrode precursor to be always apparent. In other words, the application of the separator preferably does not completely block the openings, holes, or meshes in the textile structure, whether the latter is woven or non-woven.

The non-blocking of these holes by the separator is not, however, an essential technical characteristic of the invention, and the present invention will also function when the polymeric separator does completely block the openings in the textile electrode. The reason is that the separator impregnated with a solution of a lithium salt is permeable to the lithium ions coming from the sacrificial electrode and will therefore allow these ions to pass through during the first cycling.

The optional void in the negative electrode precursor covered with the separator will be filled in subsequently by the material of the positive electrode, with the assembly formed by the negative electrode precursor, the separator impregnated with the liquid electrolyte, and the positive electrode forming an electrode module. Accordingly, it is possible to define a degree of void of the negative electrode precursor covered with the separator which is equal to the volume of the positive electrode of each electrode module related to the total volume of said electrode module. This void rate is preferably between 20% and 90%, preferably between 25% and 75%, and more particularly between 50% and 70%.

The thickness of each electrode module may vary very widely depending on the number of textile electrodes superposed on one another. The thickness is generally between 100 pm and 5 cm, preferably between 150 μm and 1 cm, and more particularly between 200 μm and 0.5 cm.

Although the application of a thin coating of separator on the textile negative electrode precursor may be carried out by various appropriate methods, such as immersion, spraying or chemical vapor deposition, this coating is preferably applied electrochemically and more particularly by a technique known by the name of cataphoresis. This technique, in which the metallic structure to be coated is introduced, as cathode, into an aqueous solution containing the base components of the coating to be applied, allows an extremely fine, regular, and continuous coating, covering the entire surface of a structure, even a structure with a highly complex geometry. In order to be able to migrate toward the cathode, in other words toward the textile structure, the component to be applied must have a positive charge. For example, the use of cationic monomers is known, which, following application to the cathode and polymerization, form an insoluble polymeric coating.

In one preferred embodiment of the accumulator precursor of the present invention, the separator is a separator applied by cataphoresis from an aqueous solution containing such cationic monomers, preferably cationic monomers containing quaternary ammonium functions. The separator is therefore preferably a polymeric coating formed by a polymer containing quaternary ammonium functions.

The lithium salts incorporated into the liquid electrolytes, which can be used in the lithium-ion accumulators, are known to the skilled person. They are generally fluorinated lithium salts. Examples include LiCF₃SO₃, LiClO₄, LiN(C₂F₅SO₂)₂, LiN(CF₃SO₂)₂, LiAsF₆, LiSbF₆, LiPF₆, and LiBF₄. Said salt is preferably selected from the group consisting of LiCF₃SO₃, LiClO₄, LiPF₆, and LiBF₄.

In general, said salt is dissolved in an anhydrous aprotic organic solvent composed generally of mixtures, in variable proportions, of propylene carbonate, dimethyl carbonate, and ethylene carbonate. Hence said electrolyte generally comprises, as is known to the skilled person, at least one cyclic or acyclic carbonate, preferably a cyclic carbonate. For example, said electrolyte is LP30, a commercial compound from the company Merck containing ethylene carbonate (EC), dimethyl carbonate (DMC), and LiPF₆, the solution containing one mole/liter of salt and identical amounts of each of the two solvents.

As explained before, the accumulator precursor of the present invention further contains at least one “sacrificial” metallic lithium electrode. This electrode is called sacrificial because, during the first cycling (charge/discharge), during which the accumulator precursor of the present invention is converted to a lithium-ion accumulator, this electrode is partly or completely consumed. This sacrificial electrode is preferably formed by a strip of metallic lithium supported by an electrical conductor. This electrical conductor is, for example, a plate of copper, and acts as an electron collector from the lithium electrode.

The accumulator precursor of the present invention has the advantage that it is able to operate with commercial strips having standard thicknesses of between 50 μm and 150 μm. Owing to the free diffusion of the lithium ions through the textile negative electrode precursors, a single sufficiently thick strip, or two strips sandwiching one or more electrode modules, make it possible for all of the negative electrode precursors to be fed with a sufficient quantity of lithium ions.

The ratio between the cumulative geometric surface area of the lithium strip or strips and the cumulative geometric surface area of all of the textile negative electrode precursors is within the range from 0.05 to 0.33, preferably from 0.1 to 0.25. In other words, preference will be given, for one lithium strip, to using 3 to 20 negative textile electrodes, preferably 4 to 10 negative electrodes, with a geometrical surface area identical to that of the lithium strip.

In the case of wound electrode modules, the sacrificial lithium electrode may surround the wound structure and/or be located in the center of said structure.

There now follows a calculation example for the dimensions of the sacrificial electrode required in order to supply the appropriate amount of lithium:

This calculation is done for a 10 Ah accumulator precursor consisting of a stack of 2 5 Ah electrode modules, which module is composed as follows:
(a) 5 textile negative electrode precursors;
(b) a polymeric separator covering the entire surface of the textile negative electrode precursors; and
(c) an LiFePO₄-based positive electrode with a capacity by mass of 160 mAh/g, a binder polymer and carbon, forming a solid matrix with a density of 2.6 g/cm³, with a capacity per unit volume (after impregnation with the electrolyte) of 323 mAh/cm³, and filling the free volume within the 5 negative electrode precursors (a) with their separator (b).

Each negative electrode precursor has an apparent density of 2.2 g/cm³, a void rate of 70%, and thickness of 152 μm. It possesses a conversion layer composed of magnetite (Fe₃O₄) with a weight of 5 mg per cm² of geometric surface area. Its capacity per unit mass during cycling is 500 mAh/g of magnetite, and the capacity required to form the nanostructured conversion layer is 924 mAh/g. Each negative electrode precursor is coated with a separator layer, with a thickness of 5 μm. The assembly of negative electrode precursor with its separator ((a)+(b)) therefore has a thickness of 152 μm+2*5 μm=162 μm and a void rate of 48%.

On cycling, each module comprising 5 textile negative electrodes will have a capacity of 5*5 mg/cm²*500 mAh/g=12.5 mAh/cm². The thickness of a module of textile negative electrodes with their separator is 5×162 μm=810 μm. The volume occupied by one module, in other words by the 5 textile negative electrode precursors with their separator, is

$$\frac{5000 mAh}{12.5 mAh \text{/} {cm}^{2}} * 810 \cdot {10}^{- 4} cm = 32.4 {cm}^{3} .$$

The void rate in the assembly of negative electrode precursor with its separator ((a)+(b)) is 48%, and so the free volume within the negative textile electrode precursor with its separator is 32.4 cm³*0.48=15.5 cm³. The capacity of the positive electrode occupying this volume of 15.5 cm³ will be 15.5 cm³×323 mAh/cm³=5 Ah. This capacity is the same as that of the module of textile negative electrodes which is combined with it for harmonious functioning of the accumulator. During the first charge/discharge cycle, the textile negative electrode will therefore retain 924 mAh/g−500 mAh/g=424 mAh/g of lithium within its conversion layer, i.e., 424 mAh/g*5 mg/cm²=2.12 mAh/cm².

Now, in order to supply a capacity of 2.12 mAh/cm², a sacrificial metallic lithium electrode according to a process of electrochemical oxidation of the metallic lithium to form lithium ions must have a minimum thickness of

$$\frac{2.12}{1000} Ah \text{/} {cm}^{2} * \frac{1}{26.8 Ah \text{/} mol} * 6.9 g \text{/} mol * \frac{1}{0.54 g \text{/} {cm}^{3}} = 1.01 \cdot {10}^{- 3} cm = 10.1 μm$$

Accordingly, an accumulator precursor composed of two electrode modules, each composed of 5 textile negative electrode precursors with their separator, and the free volume of which is filled by a positive electrode as described previously, will require a lithium strip with a minimum thickness of 10*10.1 μm=101 μm.

Furthermore, as already mentioned in the introduction, it may be of interest to oversize the sacrificial lithium electrode in such a way that it is not completely consumed during the step of conversion of the accumulator precursor. The reason is that this residual lithium electrode will be able to be used advantageously, at the end of life of the accumulator, to recover, in the form of metallic lithium, the lithium incorporated in the negative and positive electrodes of the accumulator, and hence to facilitate the recycling of the accumulator. The method of recovery of the lithium then comprises a number of steps:
(1) a step of complete recharge (i.e., complete extraction of the lithium ions) of the negative electrodes on the sacrificial electrode;
(2) a step of complete discharge (i.e., a complete extraction of the lithium ions) of the positive electrodes on the sacrificial electrode;
(3) a step of opening and removal of the electrolyte; and
(4) a step of recovery of the metallic lithium either by mechanical removal or by melting of the lithium at a temperature greater than 180° C. and recovery by gravitational flow.

The accumulator precursor of the present invention preferably comprises a plurality of electrode modules of planar form and of identical dimensions that are superposed in parallel to one another.

Two electrode modules are preferably separated by an electron collector, inserted between them, in electrical contact with the positive electrode (c). So as not to prevent the free diffusion of the lithium ions coming from the sacrificial lithium electrode throughout all the electrode modules, the electron collector comprises a certain number of openings spread preferably uniformly over its entire surface. The electron collector of the positive electrode is, for example, a metallic grid or a metallic textile structure. The electron collector of the positive electrode is preferably composed of a metal selected from nickel, aluminum, titanium, or stainless steel. In one preferred embodiment, the electron collector is formed by one or more aluminum grids arranged parallel to the plane of the electrode module or modules and intercalated between them.

The voids or openings in the electron collector of the positive electrode (c) are filled with the material of the positive electrode, thus establishing a continuity of ion conduction between two adjacent electrode modules.

The metallic lithium strip forming the sacrificial electrode is preferably placed against the stack of electrode modules such that the plane of the strip is parallel to the plane of the electrode module or modules and hence parallel to the plane of the textile negative electrodes. As already mentioned above, the lithium strip is not in electrical contact with the positive electrode; instead, an ion-conducting separator is inserted between the two.

In one preferred embodiment, a lithium strip, supported by an electron collector, is provided on either side of the stack of electrode modules. The lithium strip or strips preferably cover the entirety of one or of both main faces of the stack.

The lithium-ion accumulator precursor of the present invention is converted to an accumulator by a two-step method:
a first step of electrochemically reducing the negative electrode precursor or precursors by the sacrificial electrode. In the course of this step, the metallic lithium strip is consumed entirely or partly and the lithium ions migrate through the separator of the sacrificial electrode, the material of the positive electrode, the separator of the negative electrode toward the oxide layer of the negative electrode precursor, with which they react, in a partially irreversible way, to form the nanostructured conversion layer which constitutes the active material of the final negative electrode;
a second step of electrochemical reduction by the positive electrode. In the course of this step, the lithium ions from the positive electrode migrate through the separator of the negative electrode, and insert themselves reversibly into the nanostructured conversion layer formed during the preceding step.

The present invention accordingly provides a method for manufacturing a lithium-ion accumulator from a lithium-ion accumulator precursor as described above, said method comprising:
a step of electrochemically reducing the negative electrode precursor or precursors by the lithium electrode, this step comprising the application of a potential or a current between the negative electrode and the lithium electrode and effecting the partial or total consumption of the lithium electrode, until the surface oxide layer of the negative electrode precursor or precursors has been transformed, partially or completely, into a nanostructured conversion layer, and
(ii) a step of electrochemically reducing the precursor of the negative electrode by the positive electrode of the accumulator precursor, this step comprising the passage of a current from the positive electrode to the negative electrode until the positive electrode is entirely charged,
these two steps being able to be carried out in this order, but also in the reverse order; that is, the step of reducing the precursor of the negative electrode by the positive electrode being able to precede the step of reducing by the sacrificial lithium electrode.

In the course of step (i), the metallic lithium electrode is connected to the negative electrode precursor via their respective connectors (electron collectors) and a potential is applied, generally of between 0.5 and 1.5 V, so as to induce electrochemical oxidation of the lithium electrode, electrochemical reduction of the oxide layer of the negative electrode precursor, and a slow diffusion of the lithium ions from the lithium electrode to the oxide layer of the negative electrode precursor.

In one embodiment, this step (i) is continued until the lithium electrode has completely disappeared.

In another embodiment, the step (i) is stopped before complete disappearance of the lithium electrode, so as to conserve a residual lithium electrode which is useful, at the end of life of the accumulator, for the recycling of the lithium.

In the course of this first step, preference is given to applying a relatively high potential first of all and then an increasingly low potential: The potential applied is reduced thus preferably in stages—that is, the value of the potential is maintained for a given time until the current intensity becomes too low, and then the value of the potential is reduced, before being maintained again at this new value, until the current intensity has again reached a low value.

The attainment of this low current value corresponds to the attainment of a state in which the concentration of lithium ions in the accumulator is sufficiently homogeneous, in other words in which the concentration gradient of lithium ions (necessary for the passage of the current) in the accumulator is low. This signifies that the various negative electrode precursors have reached the same level of potential relative to the sacrificial lithium electrode. The method involving successive decreasing stages in potential thus makes it possible to allow the lithium ions the time to diffuse inside the accumulator precursor and therefore to the different negative electrode precursors which make up this accumulator precursor, and to do so at each stage of applied potential.

When the sacrificial electrode has been completely consumed or when an amount of lithium ions corresponding to the amount of lithium ions which remains fixed in the conversion layer of the negative electrode in a definitive or desired manner has been provided to the negative electrode precursor, the negative textile electrode or electrodes are connected, via a current source or potential source, to the current collectors of the positive electrode, and the accumulator is given a first discharge by passing a current through it until the end-of-discharge potential of the accumulator has been reached.

### EXAMPLES

### Example 1

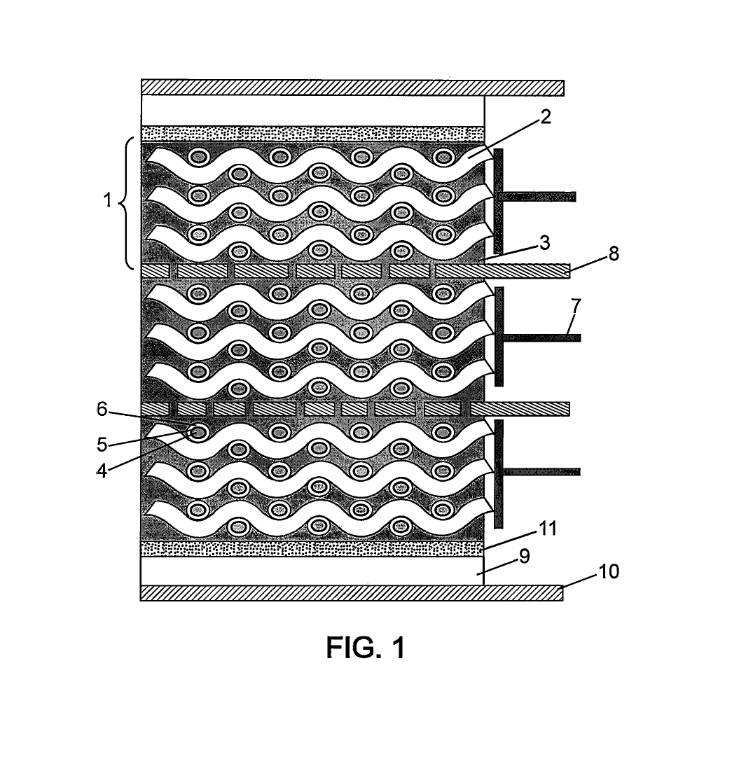

The accumulator precursor shown in FIG. 1 comprises three electrode modules 1 each comprising three negative electrode precursors 2 stacked one upon another. The negative electrode precursors here have a woven textile structure with weft wires shown in transverse section and warp wires in longitudinal section. Each wire of negative electrode precursor comprises a central metallic portion 4, surrounded by an oxide layer 5, said oxide layer being covered in turn by a thin separator layer 6.

The wires 2 of the negative electrodes are enclosed in a solid, continuous matrix forming the positive electrode 3. The negative electrode precursors 2 are joined to electrical connectors 7 and the positive electrode 3 is in electrical contact with the electrical connectors 8. The electrical connectors 8 of the positive electrode are aluminum grids disposed alternately with the electrode modules 1. The material of the positive electrode 3 not only completely surrounds the wires of the negative electrode precursors 2 but also fills the voids in the electrical connectors 8 of the positive electrode, thereby producing a continuous network of positive electrode extending throughout the volume of the accumulator. The accumulator precursor shown here comprises two sacrificial electrodes each formed by a strip 9 of metallic lithium applied to a metal connector 10. The strip of metallic lithium is separated from the positive electrode 3 by a thin layer of a separator 11.

### Example 2

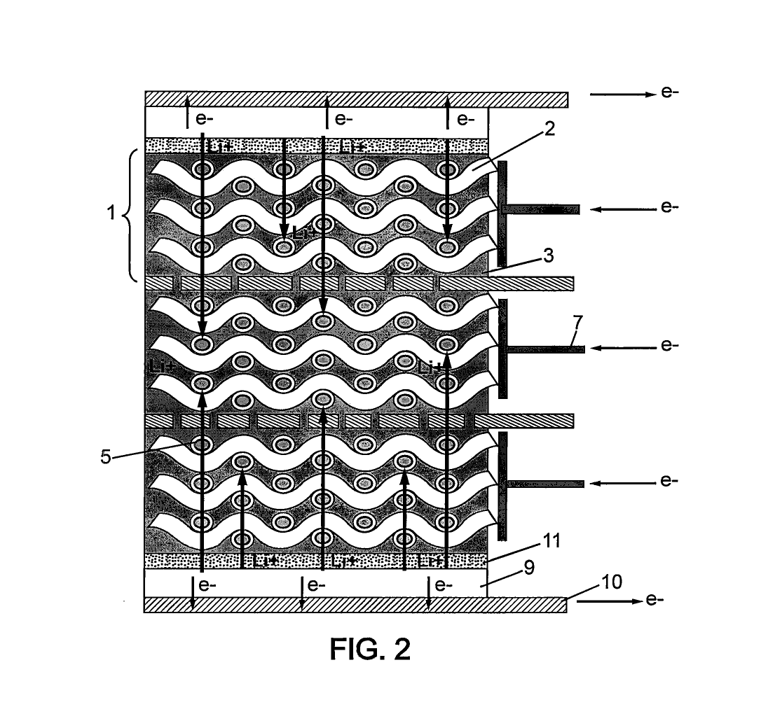

FIG. 2 shows the electrochemical process during the first step of conversion of the accumulator precursor to an accumulator. Application of a potential between the connectors 7 of the negative electrode 2 and the connectors 10 of the sacrificial electrode 9 causes the migration of the lithium ions from the sacrificial electrode 9 via the positive electrode to the oxide layer 5 of the negative electrode precursor 2.

### Example 3

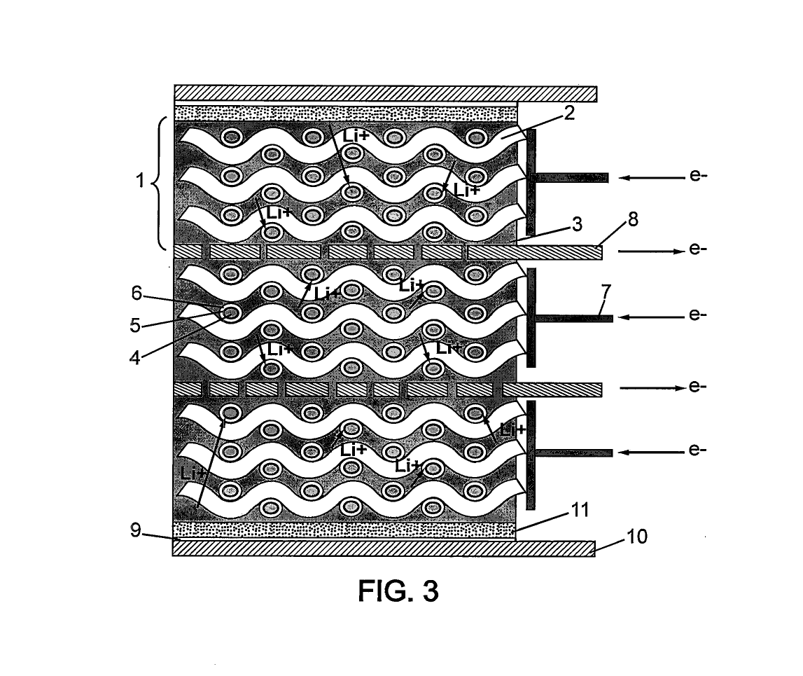

FIG. 3 shows the electrochemical process during the second step of the method of the invention. The sacrificial electrode 9 has almost completely disappeared during the preceding stage represented in FIG. 2. The connectors 7 of the negative electrode precursors 2 are no longer joined to the connector 10 of the sacrificial electrode, but to the connectors 8 of the positive electrode 3, via a voltage source or current source. The lithium ions of this latter then migrate to the oxide layer 5 partially converted, during the preceding step, into nanostructured conversion layer.

The invention will be further described by the following numbered paragraphs:

1. A lithium-ion accumulator precursor, comprising:
one or more electrode modules (1) each formed by
   (a) at least one textile negative electrode precursor (2), composed of a textile metallic structure (4), oxidized at the surface (5), based on one or more transition metals from groups 4 to 12 of the Periodic Table of the Elements,
   (b) a polymeric separator (6), impregnated with a solution of a lithium salt in an aprotic organic solvent, said separator covering the entire surface of the textile negative electrode precursor,
   (c) a positive electrode (3) forming a solid, preferably continuous, matrix which encloses the structure formed by (a) and (b), and
at least one metallic lithium electrode, formed by a metallic lithium strip (9) supported by an electrical conductor (10), and separated from the electrode module or modules by a polymeric separator (11) impregnated with a solution of a lithium salt in an aprotic organic solvent,

characterized in that the ratio of the geometric surface area of the lithium strip to the cumulative geometric surface area of all of the textile negative electrode precursors is within the range from 0.05 to 0.33, preferably from 0.1 to 0.25.

2. The accumulator precursor according to paragraph 1, wherein the surface-oxidized metallic textile structure is a non-woven structure formed of short fibers preferably having an average length of between 1 cm and 50 cm, preferably between 2 cm and 20 cm, and an equivalent diameter of between 5 μm and 50 μm.

3. The accumulator precursor according to paragraph 1, wherein the textile metallic structure is made of unalloyed or low-alloy steel.

4. The accumulator precursor according to paragraph 1, wherein a plurality of plane- shaped electrode modules of identical dimensions are superposed in parallel with one another.

5. The accumulator precursor according to paragraph 1, characterized in that the plane of the lithium strip of the lithium electrode is parallel to the plane of the electrode module or modules.

6. The accumulator precursor according to paragraph 1, further comprising an electron collector (8), in electrical contact with the positive electrode (c) of each of the electrode modules, said electron collector being formed preferably by one or more aluminum grids arranged parallel to the plane of the electrode module or modules and intercalated between them.

7. A method for producing a lithium-ion accumulator from a lithium-ion accumulator precursor according to paragraph 1, comprising the steps of:
(i) electrochemically reducing the negative electrode precursor or precursors by the sacrificial metallic lithium electrode, this step comprising the application of a potential or a current between the negative electrode and the lithium electrode and leading to the partial or total consumption of the sacrificial metallic lithium electrode, until the superficial oxide layer of the negative electrode precursors has been partly or totally converted into a nanostructured conversion layer,
(ii) electrochemically reducing the negative electrode precursor or precursors by the positive electrode of the accumulator precursor, this step comprising the passing of a current from the positive electrode to the negative electrode until the positive electrode is completely charged,
it being possible for these two steps to be carried out in this order or in the reverse order.

8. The method according to paragraph 7, wherein step (i) is continued until complete disappearance of the sacrificial metallic lithium electrode.

9. The method according to paragraph 7, wherein step (i) is halted before complete disappearance of the sacrificial metallic lithium electrode.

10. The according to paragraph 7, wherein during step (i), an increasingly low potential is applied, the applied potential being reduced preferably in stages.

It is to be understood that the invention is not limited to the particular embodiments of the invention described above, as variations of the particular embodiments may be made and still fall within the scope of the appended claims.

1. A lithium-ion accumulator precursor, comprising:
one or more electrode modules (1) each formed by
(a) at least one textile negative electrode precursor (2), composed of a textile metallic structure (4), oxidized at the surface (5), based on one or more transition metals from groups 4 to 12 of the Periodic Table of the Elements,
(b) a polymeric separator (6), impregnated with a solution of a lithium salt in an aprotic organic solvent, said separator covering the entire surface of the textile negative electrode precursor,
(c) a positive electrode (3) forming a solid, preferably continuous, matrix which encloses the structure formed by (a) and (b), and
at least one metallic lithium electrode, formed by a metallic lithium strip (9) supported by an electrical conductor (10), and separated from the electrode module or modules by a polymeric separator (11) impregnated with a solution of a lithium salt in an aprotic organic solvent,
characterized in that the ratio of the geometric surface area of the lithium strip to the cumulative geometric surface area of all of the textile negative electrode precursors is within the range from 0.05 to 0.33, preferably from 0.1 to 0.25.

2. The accumulator precursor according to claim 1, wherein the surface-oxidized metallic textile structure is a non-woven structure formed of short fibers preferably having an average length of between 1 cm and 50 cm, preferably between 2 cm and 20 cm, and an equivalent diameter of between 5 μm and 50 μm.

3. The accumulator precursor according to claim 1, wherein the textile metallic structure is made of unalloyed or low-alloy steel.

4. The accumulator precursor according to claim 1, wherein a plurality of plane-shaped electrode modules of identical dimensions are superposed in parallel with one another.

5. The accumulator precursor according to claim 1, characterized in that the plane of the lithium strip of the lithium electrode is parallel to the plane of the electrode module or modules.

6. The accumulator precursor according to claim 1, further comprising an electron collector (8), in electrical contact with the positive electrode (c) of each of the electrode modules, said electron collector being formed preferably by one or more aluminum grids arranged parallel to the plane of the electrode module or modules and intercalated between them.

7. A method for producing a lithium-ion accumulator from a lithium-ion accumulator precursor according to claim 1, comprising the steps of:
(i) electrochemically reducing the negative electrode precursor or precursors by the sacrificial metallic lithium electrode, this step comprising the application of a potential or a current between the negative electrode and the lithium electrode and leading to the partial or total consumption of the sacrificial metallic lithium electrode, until the superficial oxide layer of the negative electrode precursors has been partly or totally converted into a nanostructured conversion layer,
(ii) electrochemically reducing the negative electrode precursor or precursors by the positive electrode of the accumulator precursor, this step comprising the passing of a current from the positive electrode to the negative electrode until the positive electrode is completely charged,
it being possible for these two steps to be carried out in this order or in the reverse order.

8. The method according to claim 7, wherein step (i) is continued until complete disappearance of the sacrificial metallic lithium electrode.

9. The method according to claim 7, wherein step (i) is halted before complete disappearance of the sacrificial metallic lithium electrode.

10. The according to claim 7, wherein during step (i), an increasingly low potential is applied, the applied potential being reduced preferably in stages.
